(19) United States
(12) Patent Application Publication
(10) Pub. No.: US 2010/0274797 A1
(43) Pub. Date: Oct. 28, 2010

(54) Method and System for Multi-Input Hierarchical Content Navigation

(76) Inventor: Steffen Tichatschke, Soquel, CA (US)

Correspondence Address: Steffen Tichatschke;Soquel Technologies, LLC, P.O. Box 1866, Capitola, CA, 95010, US

(21) Appl. No.: 12/432,633

(22) Filed: Apr. 29, 2009

Related U.S. Application Data
(60) Provisional application No. 61/173,592, filed on Apr. 28, 2009.

(51) Int. Cl. G06F 17/30

(52) U.S. Cl. 707/769; 707/E17.108

(57) ABSTRACT

The present invention provides a method and user interface to navigate a hierarchical content catalog comprised of categories, sub-categories and individual content items. Components of the invention are the specific combination of user input capabilities; the combination of display elements; their defined spatial relationship to each other; their individual graphical appearance; and the methodology of how user input actions modify the displayed content within certain display elements. The main benefit of the present invention is its intuitive user interface, enabling the integration of multiple user inputs in order to present context sensitive content choices for selection.

### CROSS-REFERENCE TO RELATED APPLICATIONS

This application is the corresponding non-provisional application for provisional application No. 61/173,592 filed on Apr. 28, 2009.

### BACKGROUND OF THE INVENTION

One of the challenges in information system solutions is how to present a complex hierarchy of content choices. A typical requirement is the ability to obtain user input in order to both navigate through the content catalog and to make a content selection. A content catalog comprises a collection of categories, sub-categories and content items.

### SUMMARY OF THE INVENTION

The present invention consists of a method and graphical user interface system to present a hierarchical content catalog to a user, and to enable the user to reach a content selection, based on the ability to provide multiple user inputs.

### DESCRIPTION OF DRAWINGS

FIG. 1 shows a functional schematic of the graphical content navigation interface

### DETAILED DESCRIPTION OF INVENTION

The present invention provides a method and graphical user interface system for content presentation and selection of content, where the content is organized in a hierarchical content catalog. A content catalog comprises categories, sub-categories and individual content items. Throughout this patent application the term content categories or categories shall also include content sub-categories, and the term content items shall include both content categories and individual content items. The combination of both presentation capabilities and selection capabilities shall be referred to as navigation.

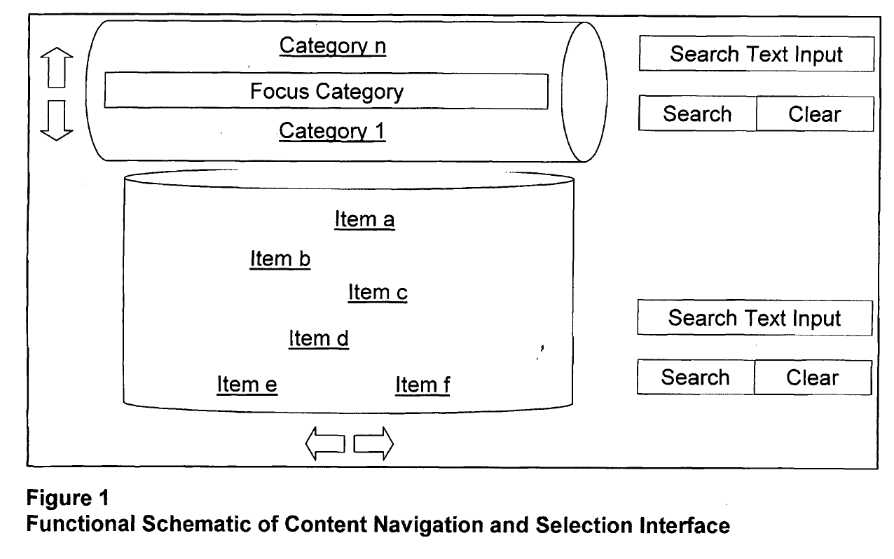

The main benefit of the present invention is its intuitive user interface, enabling the integration of multiple user inputs in order to present context sensitive content choices. FIG. 1 shows the user interface including the specific set and the graphical design of the display and user input capabilities claimed by the present invention.

In detail, the user input capabilities are:
A horizontal cylinder displaying content categories and containing a focus field. When the user selects the focus field, a list of possible content category selections is displayed on the screen. The user may choose any one of the newly displayed categories. Upon selection of a new category, the categories displayed within the horizontal cylinder surrounding the focus field will update to the new context defined by the newly selected category.
A set of “up” and “down” arrow buttons near the horizontal cylinder. Upon selecting one of the buttons, the displayed content categories within the cylinder surrounding the focus field will update, displaying new choices of available content categories.
A text input field with corresponding “search” and “clear” buttons near the horizontal cylinder. Upon entering a search text into the text field and selecting the search button, the category in the focus field will update to display the category most closely matched with the search request. All other categories displayed within the horizontal cylinder will represent content categories next closely matched to the search request. The set of up and down buttons described above will retain their functionality of moving forward and backward through the set of available content categories defined by the context of the search request. Upon selecting the “clear” button, the search context will be removed and the categories displayed in the horizontal cylinder will update to reflect that no search context has been applied.
A vertical cylinder displaying content items that correspond to the content category displayed in the focus field of the horizontal cylinder.
A set of “left” and “right” arrow buttons located near the vertical cylinder. Upon selecting one of the buttons, the displayed content items within the vertical cylinder will update, displaying new choices of available content items.
A text input field with corresponding “search” and “clear” buttons near the vertical cylinder. Upon entering a search text into the text field and selecting the search button, the content items displayed within the vertical cylinder will represent content items most closely matched to the search request. The set of left and right buttons described above will retain their functionality of moving forward and backward through the set of available content items defined by the context of the search request. Upon selecting the “clear” button, the search context will be removed, and the items displayed within the vertical cylinder will update to reflect the context defined by the content category that is displayed in the focus field of the horizontal cylinder.
Hyperlink capability of all displayed content items. Each displayed content category item within the horizontal cylinder has hyperlink capability, so that when selected, it will update the available content items within the vertical cylinder to match content items corresponding to the selected category. Each displayed content item within the vertical cylinder has hyperlink capability, so that when selected, it will navigate to another user interface for the selected content item. Both appearance and available user actions of such linked-to user interface for a content item are not within the scope of the present invention.

When presented with a user interface consisting of above described navigation capabilities, the user can navigate a hierarchical content catalog consisting of content categories and corresponding content items in the following ways:
By selecting a focus category within the focus field of the horizontal cylinder. The content categories within the horizontal cylinder will update to correspond to the newly selected focus category. The content items within the vertical cylinder will update to correspond to the newly selected focus category.
By selecting the “up” or “down” buttons located near the horizontal cylinder in order to navigate through the available content categories.
By entering a search string into the input field located near the horizontal cylinder to restrict the list of available content categories by a certain search context. Conversely, by selecting the corresponding “clear” button that context restriction from the previous search is removed.
By selecting a content category within the horizontal cylinder via its hyperlink. This will move that particular content category to the focus field and update both the surrounding categories within the horizontal cylinder and the corresponding content items within the vertical cylinder.
By selecting the “left” or “right” buttons located near the vertical cylinder in order to navigate through the set of available content items.
By entering a search string into the input field located near the vertical cylinder to restrict the set of content items available for display by a certain search context. Conversely, by selecting the corresponding “clear” button that context restriction from the previous search is removed.
By selecting a content item within the vertical cylinder via its hyperlink. This will navigate the user to another interface for the individual content item. Such linked-to user interface is not within the scope of the present invention.

1. A method for navigating a complex hierarchical structure of content categories and corresponding content items, comprising the following specific set of display and user input capabilities, their graphic appearance and specified spatial relationship, as illustrated in FIG. 1:
A horizontal cylinder displaying content categories.
A focus field within the horizontal cylinder, that when selected enables selection of a new content category.
A set of “up” and “down” arrow buttons located near the horizontal cylinder that, when selected, update the displayed content categories within the horizontal cylinder.
A text search input field with corresponding “search” and “clear” buttons, located near the horizontal cylinder, with the search result affecting the displayed items within the horizontal cylinder. Conversely, by selecting the corresponding “clear” button that context restriction from the previous search is removed and the available content items within the horizontal cylinder are updated.
A vertical cylinder displaying content items.
A set of “left” and “right” arrow buttons located near the vertical cylinder that, when selected, update the displayed content items within the vertical cylinder.
A text search input field with corresponding “search” and “clear” buttons, located near the vertical cylinder, with the search result affecting the displayed items within the vertical cylinder. Equally, when “clear” is selected, the available content items within the vertical cylinder will not be restricted by a search context.
The hyperlink capability of both displayed content categories and content items.

2. The user interface component of claim 1, consisting of the following graphical elements and their specified spatial relationship to each other:
A horizontal cylinder displaying content categories.
A focus field within the horizontal cylinder.
A set of “up” and “down” arrow buttons located near the horizontal cylinder.
A text search input field with corresponding “search” and “clear” buttons, located near the horizontal cylinder.
A vertical cylinder displaying content items.
A set of “left” and “right” arrow buttons located near the vertical cylinder.
A text search input field with corresponding “search” and “clear” buttons, located near the vertical cylinder.
Hyperlink capability for each of the content categories displayed within the horizontal cylinder, surrounding the focus field.
Hyperlink capability for each of the content items displayed within the vertical cylinder.

3. The user interface component of claim 1 whereby the selection of a new content category within the focus field of the horizontal cylinder updates the displayed content categories surrounding the focus field within the horizontal cylinder.

4. The user interface component of claim 1 whereby the selection of a new content category within the focus field of the horizontal cylinder updates the displayed content items within the vertical cylinder.

5. The user interface component of claim 1 whereby the selection of a content category within the horizontal cylinder moves the selected category into the focus field, and updates the displayed content items within the vertical cylinder.

6. The user interface component of claim 1 whereby the selection of either the “up” or the “down” arrow button updates the displayed content categories surrounding the focus field within the horizontal cylinder.

7. The user interface component of claim 1 whereby entering a search string within the text search input field and subsequent selection of the “search” button, both located near the horizontal cylinder, updates the displayed content categories surrounding the focus field within the horizontal cylinder.

8. The user interface component of claim 1 whereby selecting the “clear” button located near the horizontal cylinder removes the context restriction from the previous search, and updates the displayed content categories surrounding the focus field within the horizontal cylinder.

9. The user interface component of claim 1 whereby the selection of either the “left” or the “right” arrow button updates the displayed content items within the vertical cylinder.

10. The user interface component of claim 1 whereby entering a search string within the text search input field and subsequent selection of the “search” button, both located near the vertical cylinder, updates the displayed content items within the vertical cylinder.

11. The user interface component of claim 1 whereby selecting the “clear” button located near the vertical cylinder removes the context restriction from the previous search, and updates the displayed content items within the vertical cylinder.

12. The user interface component of claim 1 whereby selecting a content item within the vertical cylinder will display a user interface for the selected content item.
